(19) United States
(12) Patent Application Publication
(10) Pub. No.: US 2003/0204596 A1
(43) Pub. Date: Oct. 30, 2003

(54) Application-based network quality of service provisioning

(76) Inventor: Satyendra Yadav, Portland, OR (US)

Correspondence Address: FISH & RICHARDSON, PC, 4350 LA JOLLA VILLAGE DRIVE, SUITE 500, SAN DIEGO, CA, 92122, US

(21) Appl. No.: 10/135,800

(22) Filed: Apr. 29, 2002

(51) Int. Cl. G06F 15/173

(52) U.S. Cl. 709/226

(57) ABSTRACT

Methods and apparatus implementing systems and techniques for providing application-based network quality of service (QoS). QoS may be provided in a connectionless packet-switched network using QoS system components placed in the network stacks of end nodes in the network. In general, in one implementation, a technique includes: examining a set of instructions embodying an invoked application to identify the invoked application, obtaining a quality-of-service policy corresponding to the identified application, and managing network communications generated by the invoked application, using the quality-of-service policy to provide a specified network quality of service to the invoked application.

### BACKGROUND

This patent application describes systems and techniques relating to providing network quality of service, for example, providing minimum quality/performance guarantees for data traffic delivery in a network.

A machine network is a collection of nodes coupled together with wired and/or wireless communication links, such as coax cable, fiber optics and radio frequency bands. A machine network may be a single network or a collection of networks (e.g., an internetwork), and may use multiple networking protocols, including internetworking protocols (e.g., Internet Protocol (IP)). These protocols define the manner in which information is prepared for transmission through the network, and typically involve breaking data into segments generically known as packets (e.g., IP packets, ATM (Asynchronous Transfer Mode) cells) for transmission. A node may be any machine capable of communicating with other nodes over the communication links using one or more of the networking protocols.

These networking protocols are typically organized by a network architecture having multiple layers, where each layer provides communication services to the layer above it. A layered network architecture is commonly referred to as a protocol stack or network stack, where each layer of the stack has one or more protocols that provide specific services. The protocols may include shared-line protocols such as in Ethernet networks, connection-oriented switching protocols such as in ATM networks, and/or connectionless packet-switched protocols such as in IP.

Many machine networks use connectionless packet-switched protocols (e.g., IP). Packets are routed separately and may thus take different paths through the network. The routers that handle these packets typically decide a next-hop route, which is likely to move a packet closer to its destination, but provide no guarantees about when or whether a packet will reach its destination. Such networks are said to provide “best-effort” communication services.

A network with quality of service (QoS) may provide minimum quality guarantees for data traffic delivery. Traffic delivery specifications may include minimum latency, jitter, throughput and packet loss guarantees. Typically, QoS systems use a policy system (including, e.g., a policy server and a policy signaling protocol) to define and manage rules governing how network resources may be used by specific users, applications and/or systems. A simple form of QoS is class of service (CoS), in which traffic is categorized into various priority levels to provide differentiated service within a best-efforts network environment.

Providing QoS in a connectionless packet-switched network, such as an IP network, can be difficult due to the unpredictable nature of packet delivery caused by the best-efforts network environment.

### DRAWING DESCRIPTIONS

FIG. 1 is a flowchart illustrating providing application-based QoS in a network.

FIG. 2 is a block diagram illustrating a networked machine implementing application-based QoS provisioning.

FIG. 3 is a block diagram illustrating a system implementing application-based QoS provisioning.

FIG. 4 is a combined state diagram and flowchart illustrating a method of operation and communication for application-based QoS system component(s) as may be implemented in the system of FIG. 3.

FIG. 5 is a combined state diagram and flowchart illustrating a method of operation and communication for a policy server as may be implemented in the system of FIG. 3.

FIG. 6 is a block diagram illustrating an example data processing system.

Details of one or more embodiments are set forth in the accompanying drawings and the description below. Other features and advantages may be apparent from the description and drawings, and from the claims.

### DETAILED DESCRIPTION

The systems and techniques described here relate to providing application-based network quality of service, for example, dynamic provisioning of machine network policies and QoS. As used herein, the term “application” means a software program, which is a collection of computing operations embodied by a set of instructions (e.g., one or more binary objects, one or more scripts, and/or one or more interpretable programs), which may be designed to operate with other applications and/or components. The term “component” means a software program, part of a software program, or other software-based resource, designed to operate with other components and/or application(s). The term “process” means one or more executing software programs, which may or may not share resources and/or an execution context. The term “execution context” means a set of processing cycles given to one or more processes, such as a task in a multitasking operating system.

The network QoS systems and techniques described here accurately identify and take into consideration the applications currently running on a computing system/machine in a networked environment. These systems and techniques may result in one or more of the following advantages. When applications invoked on a networked machine are accurately identified on the networked machine, network communications for invoked applications may be managed from within the network stack on the machine to implement QoS on a connectionless packet-switched network, such as an IP network.

Invoked applications may be identified at run time and application network Input/Output (I/O) requests may be intercepted. Rules may be dynamically added to and removed from a kernel component packet classifier to identify network flows and/or connections associated with invoked applications and to provide policy controlled QoS locally, regardless of which communications ports the application may select. Packets may be tagged according to a QoS policy, which may be application-specific. QoS parameters may be dynamically communicated to intermediate networking devices in a network.

Moreover, QoS policies may be dynamically modified, such as from a central policy server, to implement various network traffic engineering techniques for improved network performance. For example, QoS policies may vary dynamically for successive or different network flows generated by the same invoked application. Such dynamic updating of QoS policies and/or parameters may be based upon a currently monitored state of the network (e.g., monitored network congestion) and may be actively pushed to networked machines (e.g., a networked computer) and/or networking devices (e.g., multilayer switches and routers connecting the network) by a policy server.

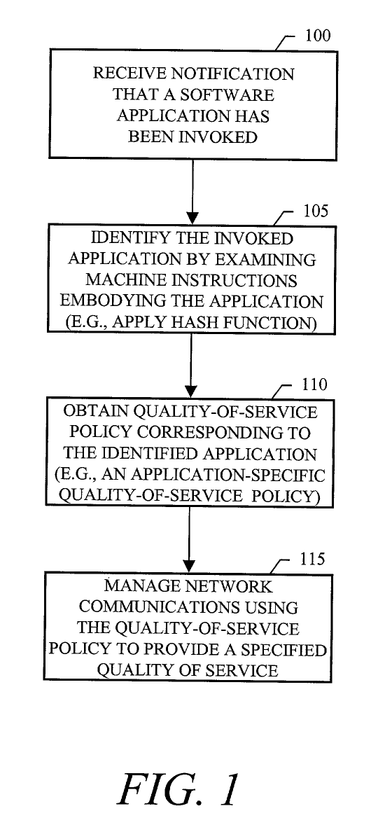

FIG. 1 is a flowchart illustrating providing application-based QoS in a network. A notification that an application has been invoked is received at 100. This notification may be explicit, such as a message being sent to a QoS provisioning system, or it may be implicit, such as a component of a QoS provisioning system being invoked when the process begins.

Next, the application is identified by examining machine instructions embodying at least a portion of the application at 105. For example, the examination of the machine instructions may involve applying a hash function to the application's executable to generate a condensed representation (or hash value) of the executable. This hash value may then be compared with predefined hash values for known applications to identify the invoked application.

The hash function may be a message digest algorithm with a mathematical property that effectively guarantees that for any size message, a unique value of a fixed size (e.g., 128 bits) is returned. The hash function may be part of a standardized message digest specification (e.g., Secure Hash Standard (SHA-1), defined in Federal Information Processing Standards Publication 180-1).

Following application identification, a QoS policy corresponding to the identified application is obtained, e.g., from a central policy server and/or from a local repository, at 110. For example, the application may be given a particular priority in an enterprise network, and the QoS policy may be application-specific or may apply to a group of applications. In an enterprise network, applications that are considered more important by the enterprise, such as an email application, a network meeting application, and other business and custom applications, may be give higher priority QoS policies.

A QoS policy may include one or more classification rules (e.g., filter plus action) for specifying CoS for generated network communications, and/or QoS scheduling parameters for identifying QoS required specifications, such as minimum throughput, packet loss, latency, and/or jitter. Moreover, the QoS policy may be multifaceted. Thus, a QoS policy may include different QoS parameters for different types of network flows that may be generated by an application, and/or different QoS parameters for different operational states of the network (e.g., levels of network congestion).

Network communications for the invoked application are managed using the QoS policy to provide a specified network quality of service at 115. This management may be implemented on a per-flow basis, and may involve dynamic loading and unloading of QoS parameters. Additionally, this management may involve dynamic updates of QoS policies using a central policy server.

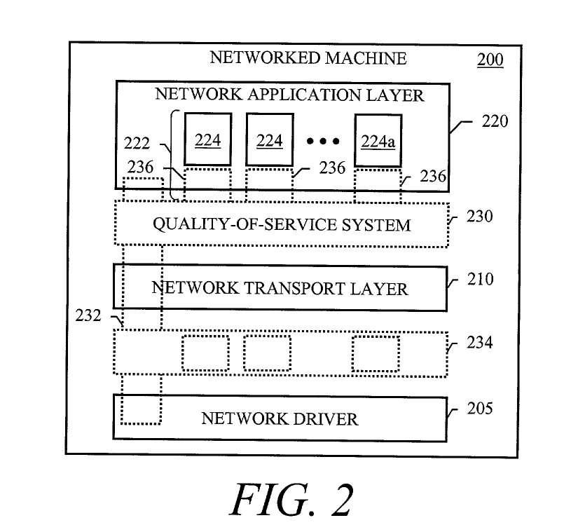

FIG. 2 is a block diagram illustrating a networked machine implementing application-based QoS provisioning. A networked machine 200 includes a network stack, which is a set of layered software modules implementing a defined protocol stack. The number and composition of layers in the network stack may vary with machine and network architecture, but generally includes a network driver 205, a network transport layer 210 (e.g., TCP/IP (Transmission Control Protocol/Internet Protocol)) and an application layer 220.

A QoS system 230 is implemented just below and/or just inside the application layer 220 (e.g., as part of a network interface library). Thus, network services requested by applications 224 are received first by the QoS system 230, which knows which application requested which network service. The QoS system 230 may include additional components 232 placed lower in the network stack. For example, the QoS system 230 may be implemented as one or more QoS kernel components 234 and application layer components 236.

Each application layer component 236 may load and run with each new network application 224 in an execution context 222 for that network application. The components 236 may perform the application-based QoS provisioning described above in conjunction with the QoS kernel component(s) 234.

The QoS system 230 may be implemented in a Windows operating system environment as a WinSock (Windows Socket) Layer Service Provider (LSP), as a TDI (Transport Driver Interface) filter driver, and/or an NDIS (Network Driver Interface Specification) intermediate driver. WinSock is an Application Programming Interface (API) for developing Windows programs that communicate over a network using TCP/IP. On Linux systems, the QoS system 230 may be implemented as a filter driver (loadable module) and/or as a virtual network device driver.

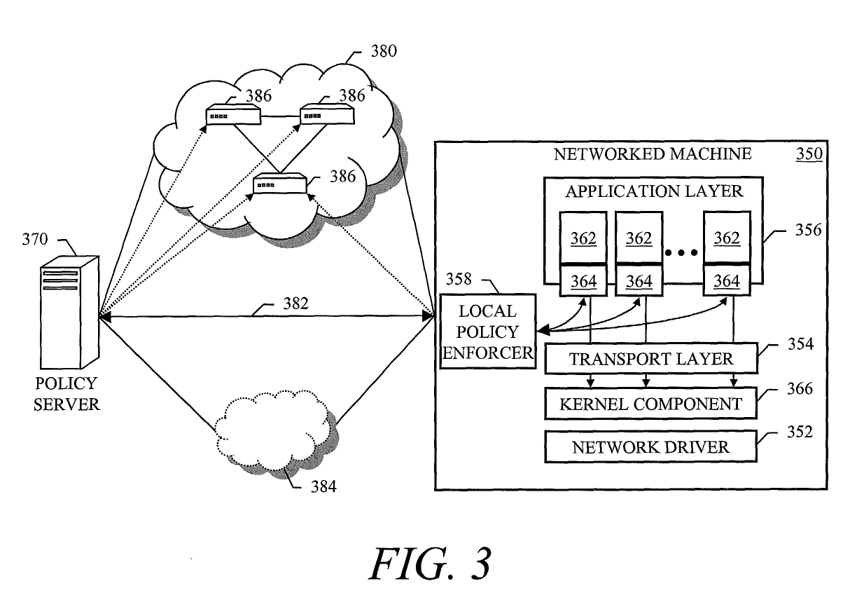

FIG. 3 is a block diagram illustrating a system implementing application-based QoS provisioning. The system includes multiple networked machines, such as a networked machine 350. The networked machine 350 includes a network driver 352 and a network transport layer 354. The machine 350 also includes an application layer 356.

Multiple network applications 362 run in the network application layer 356, and each of these applications 362 have a corresponding application-layer QoS component 364 that loads with the application and runs between the application and the network transport layer 354 (e.g., a TCP/IP stack). Each QoS component 364 communicates with a local policy enforcer 358 and a QoS kernel component 366. The local policy enforcer 358 may make QoS related policy decisions and may serve as the local repository of network QoS policies, including application-specific QoS policies.

The network QoS policies are represented using a predefined schema and may be multifaceted as discussed above. The local policy enforcer 358 and/or the QoS components 364 may communicate with a policy server 370 over a network 380 (i.e., communications 382). These communications 382 may use a protocol for communicating state information about the networked machines, the invoked applications and the network. Additionally, this protocol may enable dynamic updates of network QoS policies.

The policy server 370 may serve as a centralized master policy database and may reside in or represent an Information Technology (IT) Network Operation Center. As used herein, the term “policy server” includes a single programmed machine or multiple programmed machines that function in conjunction with each other, and may include network management functionality in addition to serving QoS policies. The policy server 370 may provide centralized storage and management facilities for network QoS policies, enabling a network policy administrator to manage the QoS policies for the network 380, and enabling dynamic updating of QoS policies on the networked machines in the network. The network 380 may be an autonomous system within the Internet, a private network, a virtual private network, a local area network, a metropolitan area network, a wide area network, a wireless network and/or an enterprise network.

In addition, the defined protocol may use encryption and/or other security techniques to safeguard the communications 382. For example the policy server 370 and the QoS system on each networked machine may communicate over a virtual private network (VPN) 384, with its own encryption and security features, or use Secure Sockets Layer (SSL) to create a secure connection.

The QoS system on each networked machine may manage network communications using the QoS policies on a per-flow basis. For example, the application-layer components 364 may dynamically download QoS parameters to the QoS kernel component 366 as new network flows and/or connections are initiated. Each QoS system may initiate QoS control interactions with other network machines and/or networking devices, including networking devices 386 in the network 380. Thus, the QoS system on the networked machine 350 may download QoS parameters to the networking devices 386 (or cause the policy server 370 to do so), send resource reservation messages (e.g., RSVP (Resource Reservation Protocol) messages) to the networking devices 386, and/or add CoS identifiers (e.g., MPLS (Multiprotocol Label Switching) labels or Diff-Serv (IP Differentiated Services) markings) to the network communications.

The networking devices 386 may be multilayer switches and/or routers. The networking devices 386 may use priority queuing and label switching, and may accept whole QoS policies, QoS parameters, and/or QoS control signals. Thus, the network 380, in combination with the policy server 370 and multiple endpoint networked machines, may implement robust admission controls, CoS and priority queuing, and bandwidth management, as well as traffic engineering techniques generally.

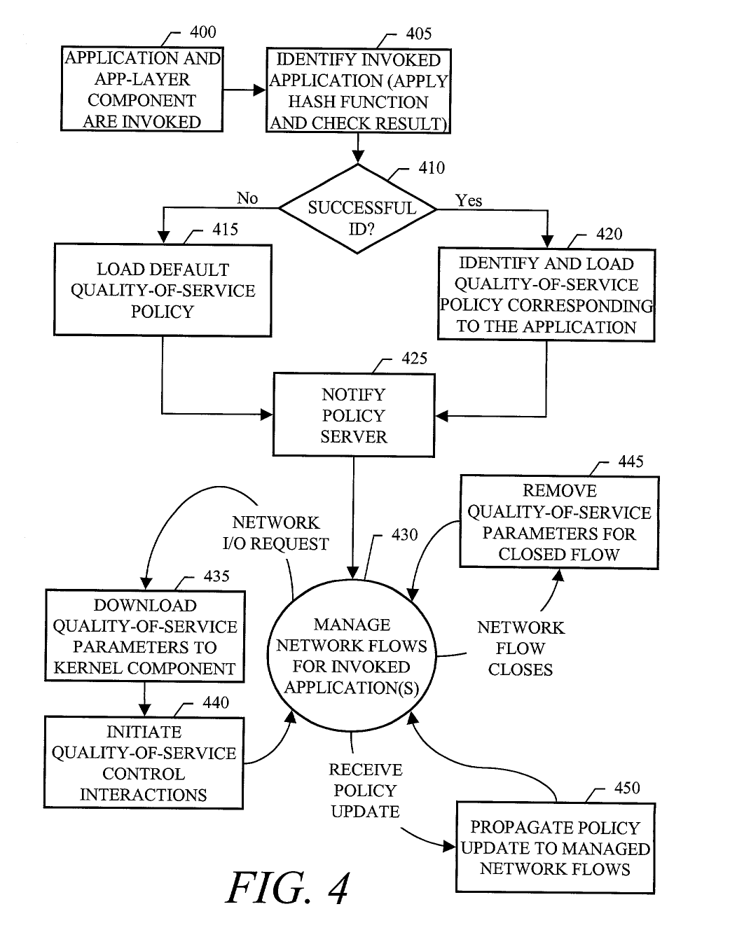

FIG. 4 is a combined state diagram and flowchart illustrating a method of operation and communication for application-based QoS system component(s) as may be implemented in the system of FIG. 3. An application and an application-layer QoS system (ALQS) component are invoked at 400. The ALQS component then identifies the invoked application at 405. For example, the ALQS component may determine the full path (directory and file name) of the loading application executable (e.g., “C:/Program Files/Application/application.exe”), examine the machine instructions, such as described above (e.g., a SHA-1 message digest of file contents), to identify the application (e.g., compare a SHA-1 message digest result to an expected value), and may also cross check this identification with file properties information, such as name, size and version number.

Then the ALQS component checks if this identification was successful at 410. If not, a default QoS policy may be loaded, such as from a local policy enforcer QoS system component (LPE) at 415. If the application is successfully identified, a QoS policy corresponding to the application is identified and loaded, such as from the LPE at 420. The QoS policy may be specific to the identified application or to a group of applications to which the application belongs. For example, applications that are likely to generate live voice and live video traffic may be grouped together and given a higher priority QoS policy. If a QoS policy corresponding to the identified application cannot be identified, a default QoS policy may be loaded.

The policy server is then notified of the loaded QoS policy for the application, either by the ALQS component or the LPE at 425. Alternatively, no default policies are used and network communications are not allowed until a QoS policy corresponding to the identified application is loaded. When a policy cannot be identified locally, a request is sent to the policy server for new QoS policy information. Additionally, periodic policy update requests may be sent (e.g., by the LPE) to maintain database synchronization.

Once a QoS policy is loaded, the QoS system manages network flows for the invoked application(s) at 430. Network I/O requests (e.g., TCP connect or listen, or UDP (User Datagram Protocol) send/sendto, recv/recvfrom) are intercepted by the ALQS component. When these network I/O requests are intercepted, QoS parameters from the QoS policy loaded for the application are downloaded to a kernel QoS (KQS) component at 435.

These QoS parameters may include the classification rule(s) and scheduling parameters as described above. The KQS component(s) may accept these QoS parameters dynamically as network flows open and close and as network QoS policies are updated. In addition, QoS control interactions with other network machines and/or devices may be initiated, as described previously at 440.

When a network flow closes, the associated QoS parameters may be removed from the KQS component at 445. When an update to a QoS policy is received, changes to QoS parameters may be propagated into the KQS component(s) for currently managed network flows at 450. Furthermore, the LPE may periodically request policy updates from the policy server and/or retrieve and send application network activity logs to the policy server.

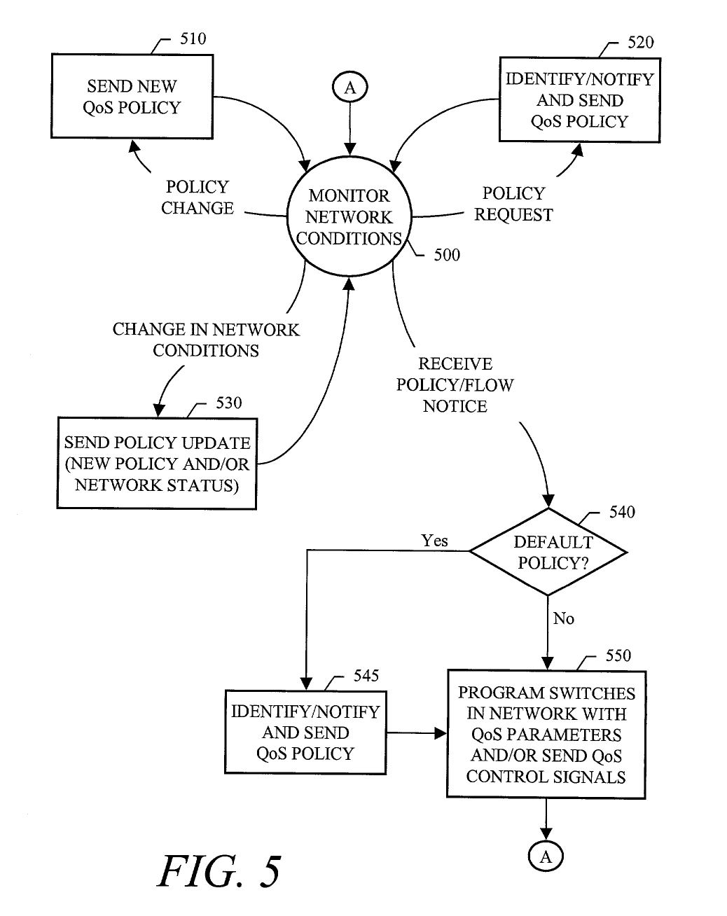

FIG. 5 is a combined state diagram and flowchart illustrating a method of operation and communication for a policy server as may be implemented in the system of FIG. 3. The method begins in a state of monitoring network conditions at 500. The policy server may provide a centralized location from which to monitor network performance and a centralized repository for QoS policies. The policy server may also serve as a central decision point for QoS policy decisions for networking devices in the network. System administrators may be responsible for creating automated network monitoring systems, generating network-condition-dependent QoS policies, and updating QoS policies in the policy server. These QoS policies may be dynamically propagated to network devices and to machines running application-based QoS systems, such as a system using ALQS, KQS and LPE components.

If a policy change is made, the new QoS policy is sent to one or more networked machines and/or devices at 510. A new QoS policy may be specific to an application and/or may be specific to a group of networked machines and/or devices. If a policy request is received, a QoS policy is identified and sent to the requester at 520. If no QoS policy can be identified, a system administrator may be notified, and a default QoS policy may be sent. Thus, new applications in a network may be identified as soon as they are initiated and before network communications are attempted. If a new application is unknown or non-approved, its network communications may be given a lowest priority QoS policy.

If a change in network conditions is identified, one or more policy updates may be sent at 530. These policy updates may include new QoS policies to be used with current network communications. These updates also may include network status updates that may affect currently loaded network-condition-dependent QoS policies.

If a notice of a loaded policy and/or an initiated flow is received, a check may be made to determine if the QoS policy being used is a default policy at 540. If so, a check is made for any new QoS policies corresponding to the invoked application, and any such new QoS policy is sent to the machine running the invoked application if such new QoS policy is identified at 545. Additionally, if no QoS policy can be identified in response to a notice of a newly loaded default policy, a system administrator may be notified of the lack of a QoS policy corresponding to the invoked application.

Then, networking devices in the network may be programmed with QoS parameters and/or QoS control signals may be sent at 550. The networking devices may be multilayer switches and/or routers in the network. Thus, in addition to being able to dynamically control QoS policies at a network endpoint (e.g., a networked computer), the policy server may be able to dynamically control network devices throughout the network as part of the dynamic application-based network QoS provisioning. The policy server may dynamically program network devices between two QoS endpoints by updating QoS policies for these devices, sending QoS parameters, and/or sending QoS control signals to these devices. Thus, the capabilities of the dynamic QoS provisioning system may be extended to implement network traffic engineering techniques generally.

Various implementations of the systems and techniques described here may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

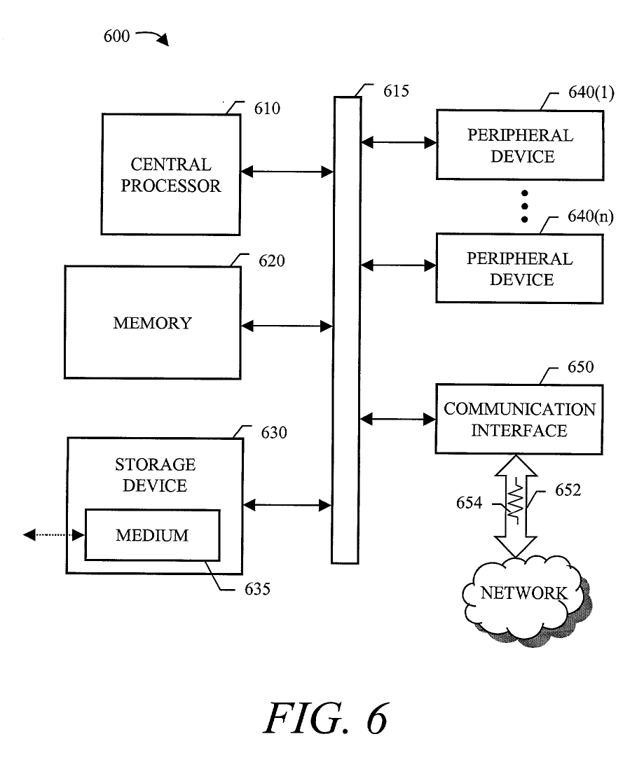

FIG. 6 is a block diagram illustrating an example data processing system 600. The data processing system 600 includes a central processor 610, which executes programs, performs data manipulations and controls tasks in the system 600. The central processor 610 is coupled with a bus 615 that may include multiple busses, which may be parallel and/or serial busses.

The data processing system 600 includes a memory 620, which may be volatile and/or non-volatile memory, and is coupled with the communications bus 615. The system 600 may also include one or more cache memories. The data processing system 600 may include a storage device 630 for accessing a medium 635, which may be removable, read-only or read/write media and may be magnetic-based, optical-based, semiconductor-based media, or a combination of these. The data processing system 600 may also include one or more peripheral devices 640(1)-640(n) (collectively, devices 640), and one or more controllers and/or adapters for providing interface functions.

The system 600 may further include a communication interface 650, which allows software and data to be transferred, in the form of signals 654 over a channel 652, between the system 600 and external devices, networks or information sources. The signals 654 may embody instructions for causing the system 600 to perform operations. The system 600 represents a programmable machine, and may include various devices such as embedded controllers, Programmable Logic Devices (PLDs), Application Specific Integrated Circuits (ASICs), and the like. Machine instructions (also known as programs, software, software applications or code) may be stored in the machine 600 and/or delivered to the machine 600 over a communication interface. These instructions, when executed, enable the machine 600 to perform the features and function described above. These instructions represent controllers of the machine 600 and may be implemented in a high-level procedural and/or object-oriented programming language, and/or in assembly/machine language. Such languages may be compiled and/or interpreted languages.

As used herein, the term “machine-readable medium” refers to any computer program product, apparatus and/or device used to provide machine instructions and/or data to the machine 600, including a machine-readable medium that receives the machine instruction as a machine-readable signal. Examples of a machine-readable medium include the medium 635, the memory 620, and/or PLDs, FPGAs, ASICs. The term “machine-readable signal” refers to any signal, such as the signals 654, used to provide machine instructions and/or data to the machine 600.

The logic flows depicted in FIGS. 1, 4 and 5 do not require the particular order shown, or sequential order. In certain implementations, multitasking and parallel processing may be preferable.

Other embodiments may be within the scope of the following claims.

What is claimed is:

1. A method comprising:
examining a set of instructions embodying at least a portion of an invoked application to identify the invoked application;
obtaining a quality-of-service policy corresponding to the identified application; and
managing network communications generated by the invoked application, using the quality-of-service policy to provide a specified network quality of service to the invoked application.

2. The method of claim 1, wherein examining the set of instructions comprises:
applying a hash function to data including the set of instructions to generate a hash value of the data; and
comparing the hash value with hash values for known applications.

3. The method of claim 2, wherein examining the set of instructions further comprises examining the set of instructions in a dynamic quality-of-service provisioning system component invoked with the invoked application.

4. The method of claim 3, wherein the dynamic quality-of-service provisioning system component and the invoked application run within a single execution context.

5. The method of claim 4, wherein managing network communications comprises:
intercepting, in the dynamic quality-of-service provisioning system component, a network request from the invoked application;
programming a quality-of-service provisioning kernel component with one or more quality-of-service parameters corresponding to the network request;
filtering network communications in the quality-of-service provisioning kernel component; and
enforcing, in the quality-of-service provisioning kernel component, the one or more quality-of-service parameters.

6. The method of claim 3, wherein the quality-of-service policy comprises an application-specific quality-of-service policy.

7. The method of claim 3, wherein obtaining the quality-of-service policy comprises receiving the quality-of-service policy from a policy server.

8. The method of claim 7, wherein the policy server comprises a remote policy server, and wherein obtaining the quality-of-service policy further comprises:
requesting the quality-of-service policy from a local policy enforcer in communication with the remote policy server; and
receiving the quality-of-service policy from the local policy enforcer.

9. The method of claim 8, wherein managing network communications comprises initiating quality-of-service control interactions with networking devices.

10. The method of claim 9, wherein initiating quality-of-service control interactions comprises sending resource reservation messages to the networking devices.

11. The method of claim 9, wherein initiating quality-of-service control interactions comprises adding class-of-service identifiers to the network communications.

12. A machine-readable medium embodying machine instructions for causing one or more machines to perform operations comprising:
examining a set of instructions embodying at least a portion of an invoked application to identify the invoked application;
obtaining a quality-of-service policy corresponding to the identified application; and
managing network communications generated by the invoked application, using the quality-of-service policy to provide a specified network quality of service to the invoked application.

13. The machine-readable medium of claim 12, wherein examining the set of instructions comprises:
applying a hash function to data including the set of instructions to generate a hash value of the data; and
comparing the hash value with hash values for known applications.

14. The machine-readable medium of claim 13, wherein examining the set of instructions further comprises examining the set of instructions in a dynamic quality-of-service provisioning system component invoked with the invoked application.

15. The machine-readable medium of claim 14, wherein the dynamic quality-of-service provisioning system component and the invoked application run within a single execution context.

16. The machine-readable medium of claim 15, wherein managing network communications comprises:
intercepting, in the dynamic quality-of-service provisioning system component, a network request from the invoked application;
programming a quality-of-service provisioning kernel component with one or more quality-of-service parameters corresponding to the network request;
filtering network communications in the quality-of-service provisioning kernel component; and
enforcing, in the quality-of-service provisioning kernel component, the one or more quality-of-service parameters.

17. The machine-readable medium of claim 14, wherein the quality-of-service policy comprises an application-specific quality-of-service policy.

18. The machine-readable medium of claim 14, wherein obtaining the quality-of-service policy comprises receiving the quality-of-service policy from a policy server.

19. The machine-readable medium of claim 18, wherein the policy server comprises a remote policy server, and wherein obtaining the quality-of-service policy further comprises:
requesting the quality-of-service policy from a local policy enforcer in communication with the remote policy server; and
receiving the quality-of-service policy from the local policy enforcer.

20. The machine-readable medium of claim 19, wherein managing network communications comprises initiating quality-of-service control interactions with networking devices.

21. The machine-readable medium of claim 20, wherein initiating quality-of-service control interactions comprises sending resource reservation messages to the networking devices.

22. The machine-readable medium of claim 20, wherein initiating quality-of-service control interactions comprises adding class-of-service identifiers to the network communications.

23. A system comprising:
communication means for linking multiple machines with each other;
means for examining a set of instructions embodying at least a portion of an application invoked on at least one of said machines to identify the invoked application;
means for obtaining a quality-of-service policy corresponding to the identified application; and
means for managing network communications generated by the invoked application, using the quality-of-service policy to provide a specified network quality of service to the invoked application.

24. The system of claim 23, wherein the means for examining comprises:
means for applying a hash function to data including the set of instructions to generate a hash value of the data; and
means for comparing the hash value with hash values for known applications.

25. The system of claim 24, wherein the quality-of-service policy comprises an application-specific quality-of-service policy.

26. A system comprising:
an enterprise network including networking devices;
a policy server coupled with the network; and
a machine coupled with the network, the machine including an application-layer component to examine a set of instructions embodying at least a portion of an invoked application to identify the invoked application and to obtain a quality-of-service policy corresponding to the identified application, the machine further including a kernel component to manage quality of service relating to network flows corresponding to the invoked application using parameters from the quality-of-service policy.

27. The system of claim 26, wherein the machine further includes a local policy enforcer to receive the quality-of-service policy from the policy server and to provide the quality-of-service policy to the application-layer component.

28. The system of claim 27, wherein the policy server comprises a plurality of networked machines creating a network operations center.

29. The system of claim 28, wherein the application-layer component applies a hash function to data including the set of instructions to generate a hash value of the data, and compares the hash value with hash values for known applications.

30. The system of claim 29, wherein the enterprise network comprises an Internet Protocol network, and wherein the networking devices comprise routers and multilayer switches.
